(19) United States
(12) Patent Application Publication
(10) Pub. No.: US 2006/0010239 A1
(43) Pub. Date: Jan. 12, 2006

(54) Methods of determining usage of components by different transaction types and data processing system readable media for carrying out the methods

(75) Inventors: Thomas P. Bishop, Austin, TX (US); Michael A. Martin, Round Rock, TX (US); James M. Mott, Austin, TX (US); Timothy L. Smith, Austin, TX (US)

Correspondence Address: TOLER & LARSON & ABEL L.L.P., 5000 PLAZA ON THE LAKE STE 265, AUSTIN, TX, 78746, US

(73) Assignee: VIEO, Inc.

(21) Appl. No.: 10/880,212

(22) Filed: Jun. 29, 2004

(51) Int. Cl. G06F 15/16

(52) U.S. Cl. 709/228

(57) ABSTRACT

Methods of determining which components and their capacities within a distributed computing environment are used for a transaction type can be performed faster and more accurately compared to conventional methods. In one embodiment by separating the transaction types into groups, regression can be performed faster on data collected because the data is less “polluted” by some or all other transactions types. Also, selection of transaction types within each group can reduce or eliminate colinearities in data between different transaction types. In still another embodiment, the distributed computing environment can be allowed to catch up between running each group of transaction types. Alternatively, if multiple instances of a component are present, transactions may be routed based on transaction type to reduce the impact. Data processing system readable media can include code that includes instructions for carrying out the methods.

### RELATED APPLICATION

This application is related to U.S. patent application Ser. No. 10/755,790 entitled “Methods and Systems for Estimating Usage of Components for Different Transaction Types” by Bishop et al. filed on Jan. 12, 2004, which is assigned to the current assignee hereof and incorporated herein by reference in its entirety

### FIELD OF THE INVENTION

The invention relates in general to methods and data processing system readable media, and more particularly, to methods of determining usage of components by one or more transaction types running on a distributed computing environment and data processing system readable media for carrying out the methods.

### DESCRIPTION OF THE RELATED ART

Distributed computing environments are becoming increasingly complex. Tools are being designed and implemented that monitor parts of the distributed computing environment. Those tools do not control the distributed computing environment effectively for optimal application performance.

Theoretically, identification of only some components by a transaction type can be obtained using a conventional deterministic approach. In one example, one transaction of one transaction type may be processed on a system. As the transaction is processed, traffic between hardware components can be determined by monitoring traffic to or from hardware components connected to a network within a distributed computing environment.

This technique does not give a true, accurate, and complete picture of usage of hardware and software components by transaction types. The methodology is limited to hardware components and does not work for software components because many software components may not need to be used every time a corresponding hardware component is used. Further, some software components may be spread out over several hardware components and may share those hardware components with other software components. Additionally, even for hardware components, the information is limited to whether or not the hardware component is used (a “yes-no” output), and does not include information regarding how much of the hardware component's capacity is used by that transaction type. In summary, the conventional deterministic technique is limited to identification of hardware components and does not provide information regarding capacity used by a transaction type.

### SUMMARY

Methods of determining which components and their capacities within a distributed computing environment are used for a transaction type can be performed faster and more accurately compared to conventional methods. A plurality of allowed groups of transaction types of one or more transaction types can be processed separately at different times. In one embodiment by separating the transaction types into groups, regression can be performed faster on data collected because the data is less “polluted” by some or all other transactions types. Also, selection of transaction types within each group can reduce or eliminate colinearities in data between different transaction types. In still another embodiment, the distributed computing environment can be allowed to catch up between running each group of transaction types so that processing the transactions and collecting data for the transactions within the group of transaction types does not significantly interfere with transactions of other transaction types that still need to be processed. Alternatively, if multiple instances of a component are present, transactions may be routed based on transaction type to reduce the impact.

In one set of embodiments, a method can be used to determine usage of component(s) by transaction type(s). The method can include processing one or more transactions using a distributed computing environment. The transaction(s) may include a first transaction having a first transaction type. The method can also include collecting data from instrument(s) within the distributed computing environment during processing of the transaction(s). The method can further include determining which of the component(s) and their capacities are used by the first transaction type.

In still another set of embodiments, data processing system readable media can comprise code that includes instructions for carrying out the methods.

The foregoing general description and the following detailed description are exemplary and explanatory only and are not restrictive of the invention.

### BRIEF DESCRIPTION OF THE DRAWINGS

The present invention is illustrated by way of example and not limitation in the accompanying figures.

FIG. 1 includes an illustration of a hardware configuration of an application management and control appliance for managing and controlling an application that runs within a distributed computing environment.

FIG. 2 includes an illustration of a hardware configuration of the application management and control appliance in FIG. 1.

FIGS. 3-4 includes an illustration of a process flow diagram for a method of determining usage of component(s) by transaction type in accordance with an embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

Methods of determining which components and their capacities within a distributed computing environment are used for a transaction type can be performed faster and more accurately compared to conventional methods. A plurality of allowed groups of transaction types of one or more transaction types can be processed separately at different times. In one embodiment by separating the transaction types into groups, regression can be performed faster on data collected because the data is less “polluted” by some or all other transactions types. Also, selection of transaction types within each group can reduce or eliminate colinearities in data between different transaction types. In still another embodiment, the distributed computing environment can be allowed to catch up between running each group of transaction types so that processing the transactions and collecting data for the transactions within the group of transaction types does not significantly interfere with transactions of other transaction types that still need to be processed. Alternatively, if multiple instances of a component are present, transactions may be routed based on transaction type to reduce the impact.

A few terms are defined or clarified to aid in understanding the terms as used throughout this specification. The term “application” is intended to mean a collection of transaction types that serve a particular purpose. For example, a web site store front can be an application, human resources can be an application, order fulfillment can be an application, etc.

The term “capacity” is intended to mean the amount of utilization of a component during the execution of a transaction of a particular transaction type.

The term “component” is intended to mean a part within an application infrastructure. Components may be hardware, software, firmware, or virtual components. Many levels of abstraction are possible. For example, a server may be a component of a system, a CPU may be a component of the server, a register may be a component of the CPU, etc. For the purposes of this specification, component and resource can be used interchangeably.

The term “component type” is intended to be a classification of a component based on its function. Component types may be at different levels of abstraction. For example, a component type of server includes web servers, application servers, database and other servers within the application infrastructure. The server component type does not include firewalls or routers. A component type of web server may include all web servers within a web server farm but would not include an application server or a database server.

The term “distributed computing environment” is intended to mean a state of a collection of (1) components comprising or used by application(s) and (2) the application(s) themselves that are currently running, wherein at least two different types of components reside on different network devices connected to the same network.

The term “instrument” is intended to mean a gauge or control that can monitor or control a component or other part of an application infrastructure.

The term “logical,” when referring to an instrument or component, is intended to mean an instrument or a component that does not necessarily correspond to a single physical component that otherwise exists or that can be added to an application infrastructure. For example, a logical instrument may be coupled to a plurality of instruments on physical components. Similarly, a logical component may be a collection of different physical components.

The term “network device” is intended to mean a Layer 2 or Layer 3 device in accordance with the Open System Interconnection (“OSI”) Model.

The term “quiesce” and its variants are intended to mean allowing a distributed computing environment to complete transactions that are currently processing until completion and not processing any further transactions ready to begin processing. After the distributed computing environment is quiesced, the distributed computing environment is typically in an idling state.

The term “physical,” when referring to an instrument or a component, is intended to mean an instrument or component that exists outside of (separate from) a logical instrument or logical object to which it is associated.

The term “transaction type” is intended to mean a type of task or transaction that an application may perform. For example, an information request (also called a browse request) and order placement are transactions having different transaction types for a store front application.

As used herein, the terms “comprises,” “comprising,” “includes,” “including,” “has,” “having,” and any variations thereof, are intended to cover a non-exclusive inclusion. For example, a method, process, article, or appliance that comprises a list of elements is not necessarily limited to only those elements but may include other elements not expressly listed or inherent to such a method, process, article, or appliance. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods, hardware, software, and firmware similar or equivalent to those described herein can be used in the practice or testing of the present invention, suitable methods, hardware, software, and firmware are described below. All publications, patent applications, patents, and other references mentioned herein are incorporated by reference in their entirety. In case of conflict, the present specification, including definitions, will control. In addition, the methods, hardware, software, and firmware and examples are illustrative only and not intended to be limiting.

Unless stated otherwise, components may be bi-directionally or uni-directionally coupled to each other. Coupling should be construed to include direct electrical connections and any one or more of intervening switches, resistors, capacitors, inductors, and the like between any two or more components.

To the extent not described herein, many details regarding specific network, hardware, software, and firmware components and acts are conventional and may be found in textbooks and other sources within the computer, information technology, and networking arts.

Before discussing embodiments of the present invention, a non-limiting, exemplary distributed computing environment for using embodiments of the present invention is described. After reading this specification, skilled artisans will appreciate that many other distributed computing environments can be used in carrying out embodiments described herein and to list every one would be nearly impossible.

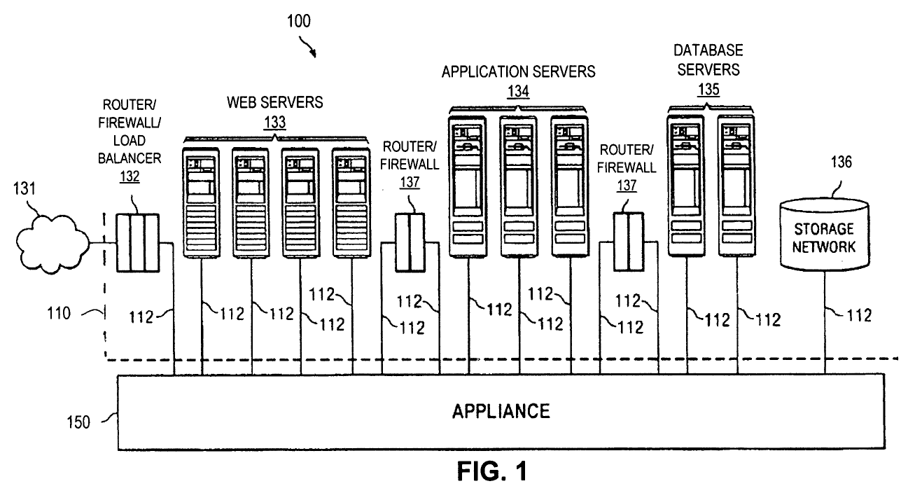

FIG. 1 includes a hardware diagram of a distributed computing environment 100. The distributed computing environment 100 includes an application infrastructure, which includes management blade(s) within an application management and control appliance (apparatus) 150 and those components above and to the right of the dashed line 110 in FIG. 1. More specifically, the application infrastructure includes a router/firewall/load balancer 132, which is coupled to the Internet 131 or other network connection. The application infrastructure further includes web servers 133, application servers 134, and database servers 135. Other servers may be part of the application infrastructure but are not illustrated in FIG. 1. Each of the servers may correspond to a separate computer or may correspond to an engine running on one or more computers. Note that a computer may include one or more server engines. The application infrastructure also includes network 112, a storage network 136 and router/firewalls 137. The management blades within the appliance 150 may be used to route communications (e.g., packets) that are used by applications, and therefore, the management blades are part of the application infrastructure. Although not shown, other additional components may be used in place of or in addition to those components previously described.

Each of the components 132-137 is bi-directionally coupled in parallel to the appliance 150 via network 112. In the case of the router/firewalls 137, the inputs and outputs from such the router/firewalls 137 are connected to the appliance 150. Substantially all of the traffic for the components 132-137 in the application infrastructure is routed through the appliance 150. Software agents may or may not be present on each of the components 132-137. The software agents can allow the appliance 150 to monitor and control at least a part of any one or more of the components 132-137. Note that in other embodiments, software agents on components may not be required in order for the appliance 150 to monitor and control the components.

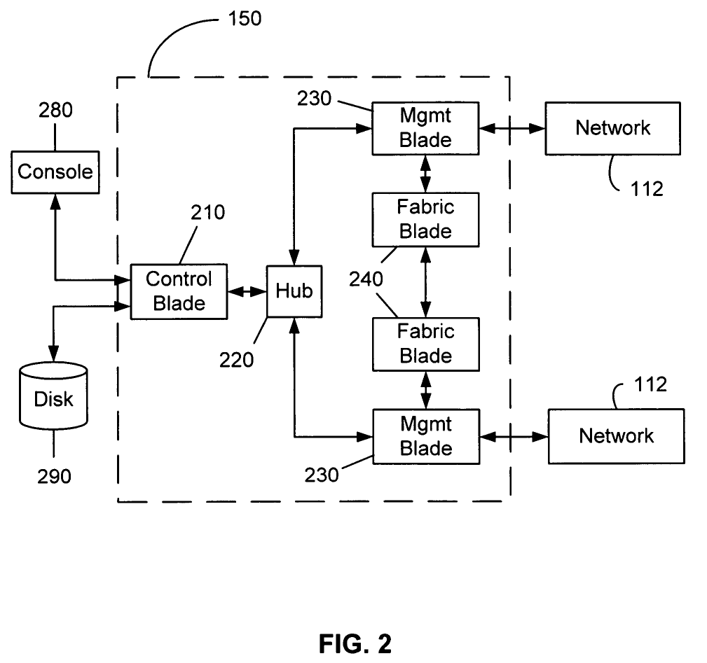

FIG. 2 includes a hardware depiction of the appliance 150 and how it is connected to other components of the distributed computing environment 100. A console 280 and a disk 290 are bi-directionally coupled to a control blade 210 within the appliance 150. The console 280 can allow an operator to communicate with the appliance 150. Disk 290 may include logic and data collected from or used by the control blade 210. The control blade 210 is bi-directionally coupled to a hub 220. The hub 220 is bi-directionally coupled to each management blade 230 within the appliance 150. Each management blade 230 is bi-directionally coupled to the network 112 and fabric blades 240. Two or more of the fabric blades 240 may be bi-directionally coupled to one another.

The management infrastructure can include the appliance 150, network 112, and software agents on the components 132-137. Note that some of the components (e.g., the management blades 230, network 112, and software agents on the components 132-137) may be part of both the application and management infrastructures. In one embodiment, the control blade 210 is part of the management infrastructure, but not part of the application infrastructure.

Although not shown, other connections and additional memory may be coupled to each of the components within the appliance 150. Further, nearly any number of management blades 230 may be present. For example, the appliance 150 may include one or four management blades 230. When two or more management blades 230 are present, they may be connected to different parts of the application infrastructure. Similarly, any number of fabric blades 240 may be present and under the control of the management blades 230. In still another embodiment, the control blade 210 and hub 220 may be located outside the appliance 150, and in yet another embodiment, nearly any number of appliances 150 may be bi-directionally coupled to the hub 220 and under the control of control blade 210.

The control blade 210, the management blades 230, or both may include a central processing unit (“CPU”) or controller. Therefore, the appliance 150 is an example of a data processing system. Although not shown, other connections and memories (not shown) may reside in or be coupled to any of the control blade 210, the management blade(s) 230, or any combination thereof. Such memories can include content addressable memory, static random access memory, cache, first-in-first-out (“FIFO”), other memories, or any combination thereof. The memories, including disk 290, can include media that can be read by a controller, CPU, or both. Therefore, each of those types of memories includes a data processing system readable medium.

Portions of the methods described herein may be implemented in suitable software code that includes for carrying out the methods. In one embodiment, the computer-executable instructions may be lines of assembly code or compiled C⁺⁺, Java, or other language code. In another embodiment, the code may be contained on a data storage device, such as a hard disk, magnetic tape, floppy diskette, optical storage device, networked storage device(s), or other appropriate data processing system readable medium or storage device.

In an illustrative embodiment of the invention, the computer-executable instructions may be lines of assembly code or compiled C⁺⁺, Java, or other language code. Other architectures may be used. For example, the functions of the appliance 150 may be performed at least in part by another apparatus substantially identical to appliance 150 or by a computer, such as any one or more illustrated in FIG. 1. Additionally, a computer program or its software components with such code may be embodied in more than one data processing system readable medium in more than one computer. Note the appliance 150 is not required, and its functions can be incorporated into different parts of the distributed computing environment 100 as illustrated in FIGS. 1 and 2.

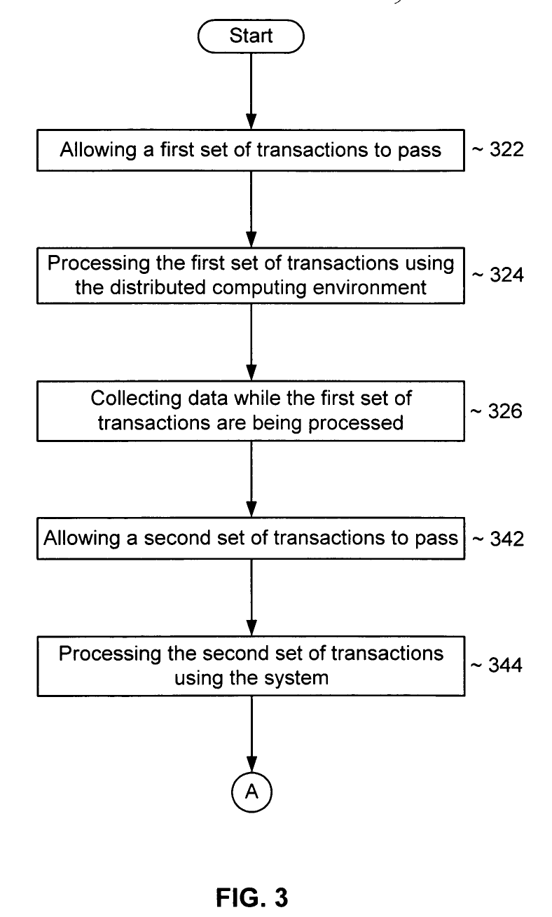

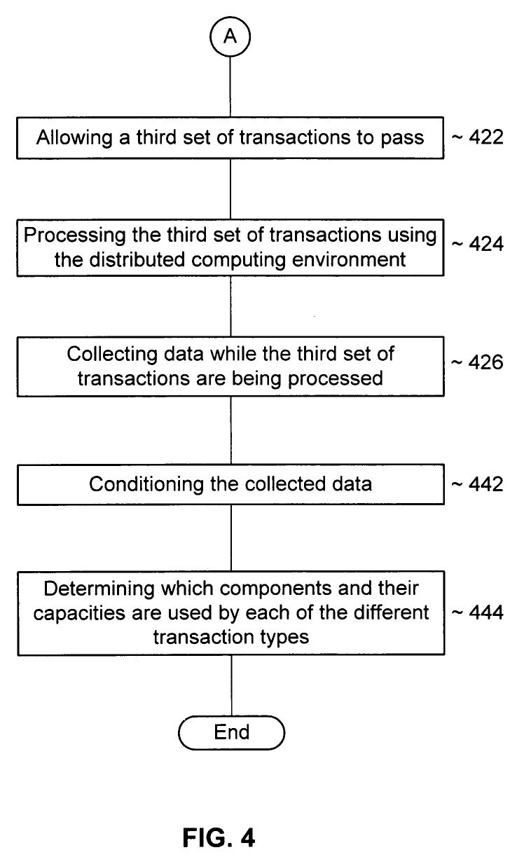

Attention is now directed to the method of determining usage of components by transaction type in accordance with one embodiment of the present invention. One embodiment of the method is illustrated in the process flow diagram of FIGS. 3-4.

Referring to FIG. 3, the method can include allowing a first set of transactions to pass (block 322). A transaction throttle can be used to determine the mix, number, or both mix and number of transactions that may be introduced into the distributed computing environment 100 as the first set of transactions. At one end of the spectrum, only a single transaction is allowed to pass. Alternatively, a plurality of transactions of the same transaction type may be allowed to pass. In still another embodiment, transactions of different transactions types may be allowed to pass. At the other end of the spectrum, all transactions except for transactions of one transaction type are allowed to pass. After reading this specification, skilled artisans are capable of determining the mix, number, or both the mix and number of transactions that should be allowed to pass for the first set of transactions. In one embodiment, the transaction throttle may use a script file or may be web based with menu selections. The exact manner of implementation to selectively allow certain transactions to pass is not critical.

The method can also include processing the first set of transactions using the distributed computing environment 100 (block 324). The transactions are processed in a manner in which they would normally be processed using the distributed computing environment 100, with the exception that other transactions (of transaction types not within the first allowed group of transaction types) would not be processed on the distributed computing environment 100 during the same time as the first set of transactions.

The method can also include collecting data while the first set of transactions are being processed (block 326). Many instruments may be used on distributed computing environment 100. The instruments can include gauges and controls and may be physical or logical. The instruments may reside on any one or more components 132-137, management blades 230, or the control blade 210. The data may be stored on hard disk 290, within memory located within the appliance 150, or within memory of the console 280 or another computer (not shown in FIG. 2).

After the first set of transactions is processed, the method includes allowing a second set of transactions to pass (block 342). While the first set of transactions are being processed, the transaction throttle may be sending transactions for transaction types not within the first allowed group of transaction types to a transaction queue. The transaction throttle may be changed to allow the second set of transactions to pass, significantly reducing the transaction queue. The method can further include processing the second set of transactions using the distributed computing environment 100 (block 344). Although not required, allowing and processing the second set of transactions helps the distributed computing environment 100 to catch up and substantially reduce or eliminate a backlog of transactions that may have built up while processing and collecting data on the first set of transactions. In this manner, the implementation may be substantially transparent to users of the distributed computing environment 100.

The distributed computing environment 100 may be allowed to quiesce, again. After the distributed computing environment 100 reaches an idling state, the method continues for a second allowed group of transaction types. As illustrated in FIG. 4, the method can include allowing a third set of transactions to pass (block 422), processing the third set of transactions using the distributed computing environment 100 (block 424), and collecting data while the third set of transactions are being processed (block 426). The activities in blocks 422-426 are nearly identical to the activities in blocks 322-326 of FIG. 3. At least one transaction type is different between the first and second allowed groups of transactions types. As compared to the first allowed group of transaction types, the second allowed group of transaction types may have more, fewer, or the same number of transaction types. One or more of the transaction types may belong to both the first and second allowed groups of transaction types. In one non-limiting example, the first allowed group may include an information request and a file request (for an image), and the second allowed group may include an order placement request and the file request.

The method can comprise conditioning the collected data (block 442). Conditioning can include any one or more of smoothing the data, filtering the data, and determining accuracy. Smoothing and filtering is typically performed before determining estimated usage. More details regarding conditioning described in more detail in U.S. patent application Ser. No. 10/755,790.

Smoothing can be used to determine a value for the data that is more reflective of the time of other readings. Smoothing can also be used to address whether relatively older data should be used (i.e., data is old enough such that is has become untrustworthy or stale).

Filtering the data can be used to remove data that does not accurately reflect normal, “near-zero” operations. Filtering can also remove data from operations that are abnormal. Filtering may be used for other reasons. After reading this specification, skilled artisans will appreciate that filters can be tailored for the distributed computing environment 100 or any part thereof as a skilled artisan deems appropriate.

The accuracy determination may be performed during or after the usage estimation. Accuracy compares actual and estimated usage of the component. The accuracy can be calculated using an R² statistic. The correlation between the predicted and the actual usage is squared. A higher value means higher accuracy. An operator may determine at what level the accuracy become high enough that he or she would conclude the correlation is significant.

The method can further include determining which components and their capacities are used by each of the different transaction types (block 444). Using the information regarding the transactions within the first and third sets of transactions, statistical methods can be run by the control blade 210 to determine which components 132-137 and their capacities are used by each of the transaction types within the first and third sets of transactions. Alternatively, the statistical methods may be performed on the console 280 or another computer. Some illustrative examples of the statistical methods are described in more detail in U.S. patent application Ser. No. 10/755,790. In one specific embodiment, regression may be used.

For example, the first allowed group of transaction types may include information requests, and the first set of transactions may be a plurality of information requests. Statistical analysis can be performed to determine that one of the web servers 132 is used and each information request uses approximately 0.3 percent of that web server's capacity. Similar statistical analysis may be performed for other components 132-137 within the distributed computing environment 100. If other transaction types are present, the procedure may be repeated for the other transactions types within the first set of transactions.

The determination of components used and their capacities for a specific transaction type can be performed faster and more accurately because the transaction throttle can control which transaction type(s) are allowed to pass. If only one transaction type is allowed to pass, any component significantly affected would be used by that transaction type. Accuracy also improves because colinearities with other transaction types does not occur since no other transactions types were allowed to pass and be processed when transactions of the first transaction type are being processed. As the number of transactions types allowed to pass increases for any set of transactions, the determination of which components and their capacities used by each transaction type may be slower, and accuracy of the determinations (because of potential colinearities in data between different transactions types) may be worse due to the presence of more than one transaction type. Still, transactions of more than one transaction type may be used within the first set of transactions and still not depart from the scope of the present invention. Each of the first and third sets of transactions will not typically include all possible transaction types.

In the embodiment previously described, all data is collected before conditioning and determination activities are performed. In such an embodiment, one large multiple linear regression can produce the better estimates of capacity which is attributed to the various transaction types as compared to performing conditioning and determination activities separately after each set of data is collected. In another embodiment, conditioning and determination activities can be performed after each act of collecting data (e.g., between blocks 326 and 342 in FIG. 3 in addition to conditioning and determination activities after block 426 in FIG. 4).

The determination of which components are used by a transaction type is typically performed using a statistical technique. However, in an alternative embodiment, a deterministic technique may be used for the identification of components used. For example, if only one transaction is allowed to pass during the first set of transactions, component(s) that are significantly affected during processing of that one transaction are due to the transaction being processed. Humans or a threshold level (as detected automatically) can be used to determine which component(s) are used. However, determining the capacity(ies) of those component(s) used by the transaction will be performed using a statistical technique. Also, the deterministic technique may not work as well when more than one transaction type are being processed.

The method is highly flexible for many different uses. Different web servers 133 within a web server farm may not be identical. For example, one web server 133 may operate using a different revision of system software compared to another web server. The previously described methodology may be repeated for each web server 133 within the web server farm. In this manner, each of the web servers 133 may be more accurately characterized.

Another use may be to extend the methodology to transactions other than those received at web servers 133. Although the application servers 134 and database servers 135 are not typically accessed by client computers (not shown) on the Internet 131, the application servers 134 and database servers 135 still process transactions, such as requests from the web servers 133. The method can be repeated for the transactions that those servers would process. For example, application servers 134 may have a transaction type for processing credit card information for proper authorization, and the database servers 135 may have a transaction type for writing inventory information to an inventory management table within a database. For servers, the capacities are typically related to CPU cycles in absolute (CPU cycles/transaction type) or relative (% of CPU capacity/transaction type) terms.

The method can be used for a variety of different components, including hardware, software, and firmware components. The method can be used for components at many different levels of abstractions. The method may be extended to registers, a CPU, and a computer, wherein the registers lie within the CPU that lies within the computer. Each of the registers, CPU, and computer is a component to which the method may be used. Similarly, the method may be extended to objects and a class, wherein the objects belong to the class, and each of the class and its corresponding objects are components.

Note that the use of the transaction queue and catching up may not be required. For example, if a web server farm has several web servers 133, transactions for transactions types within the allowed group of transaction types may be routed to one web server 133 being tested instead of the other web servers 133. Similarly, the transactions for transaction types outside the allowed group of transaction types may be routed to other web servers 133 not being tested. With such a configuration, only one transaction type at a time may be tested, and longer periods of time may be used for the testing. With a larger number of transactions of a single transaction type, determination of components and capacities used by each transaction type may be performed with a greater level of accuracy. In still another embodiment, a combination of routing and a transaction queue may be used, particularly if the other web servers 133 cannot keep up with the requests for transactions being received. After reading this specification, skilled artisans will be a capable of determining the use of queues and routing that best serve their specific needs.

### EXAMPLE

The following example is presented to better illustrate some advantages of a non-limiting embodiment that can be used. Note that the benefits, advantages, and solutions to problems that occur using this specific example are not to be construed as a critical, required, or essential feature or element of any or all the claims.

In this example, an organization operates a store front web site application. The application allows users at client computers (not shown) to access the web site via the Internet 131. In this example, the store front application may have 26 different transaction types. Some of the transaction types may include a static information request (information not updated or updated on an infrequent basis), a dynamic information request (information updated for each information request or on a frequent basis), an image request, a search request, an order placement request, and the like. Information regarding components and their capacities used by each of the transaction types can be used by the appliance 150 when managing and controlling the components 132-137 connected to the network 112.

If the distributed computing environment 100 is shut down or operating at reduced capacity for any significant period of time, the organization may lose potential revenue as users, who are also potential customers of the organization, may be unable to use the store front application or may become frustrated with the slow response time and not order any products or will only buy specific products from the web site when it is the only site selling those specific products. An organization that relies on its web site for sales cannot allow such an impediment to purchases. Therefore, the method can be designed such that it is substantially transparent (not significantly perceived) by humans using the distributed computing environment 100.

To obtain the desired information without significantly impacting customers, transaction(s) for a set of only one or some transaction types, but not all transaction types, are processed for a limited number of transaction(s) or period of time. During the limited number of transaction(s) or period of time, other transactions may be received by the web site and are held within a transaction queue. After limited number of transaction(s) or time period ends, the distributed computing environment 100 is allowed to catch up by allowing the number of transactions in the transaction queue to be substantially reduced. After the distributed computing environment 100 is allowed to catch up, transaction(s) for a different group of only one or some, but not all, transaction types are processed for another limited number of transaction(s) or another period of time.

Details of the specific implementation in this example will now be addressed. A first set of transactions may be used to determine components and their capacities used by five of the 26 transaction types used by each of the web servers 133. The methodology described below will be performed on each web server 133, individually, and therefore, the specific web server 133 being examined will be referred to as the tested web server 133. Five transactions types may be examined and form the first allowed group of transaction types, and include the static information request, dynamic search request, search request, and two other transaction types. While the method allows great flexibility to select transactions types, data from some transaction types may be suspected to have some colinearities. For example, each of the static and dynamic information requests may be used by the order placement request, and therefore, colinearities between data from each of the order placement requests and either or both of the static and dynamic information requests are suspected to have some colinearities. The first allowed group does not include the order placement request in this specific embodiment.

The distributed computing environment 100 will be allowed to quiesce before those transactions are processed. During quiescing, all newly received transactions may be sent to a transaction queue.

A transaction throttle may be adjusted to allow only transactions of the first allowed group of transaction types to pass to the tested web server 133. The actions of the transaction throttle may be carried out by one or more of the management blades 230 or software agents on the tested web server 133. After quiescing, those transactions within the first allowed group of transaction types can be processed. The transactions may include transactions from the transaction queue, newly received transactions from client computers (not shown) via the Internet (that do not go through the transaction queue), or a combination thereof. Any newly received transactions not within the first allowed group of transaction types will be sent to the transaction queue.

In theory, the time period for the transaction throttle to allow those transactions within the first allowed group of the transaction types to pass can be nearly any time length. However, in order to not give the appearance to other users of the distributed computing environment 100 that the web site is slow or having problems, the throttle may only allow transactions within the first allowed group of transaction types to pass and be processed for no longer than one minute, and in other specific embodiments, no longer than 15 seconds or even one second.

The transactions within the first allowed group of transaction types will be processed on the tested web server 133, and data will be collected from instruments as previously described.

After the transactions within the first allowed group of transaction types complete processing on the tested web server 133, the transaction throttle will be adjusted to remove the restriction to allow transactions, including those transactions outside the first allowed group of transaction types, to be processed. Effectively, the transaction queue that built up during processing transactions only within the first allowed group of transaction types will be substantially reduced or even emptied. In a worse case scenario, users at the client computer may see an insignificant increase in processing time for their transactions requested, but such an increase, even if it can be perceived, would not frustrate the users and cause them to consider not using the web site. The transaction throttle may now perform another test for nearly any period of time. In one embodiment, the transaction throttle may limit the tests performed to once every 15 minutes to one hour, so that most users would only be using the distributed computing environment 100 for one round of testing. Still, the time between tests could be significantly longer or shorter than the period given.

The transaction throttle may again be adjusted to only allow transactions of a second allowed group of transaction types to pass. The second allowed group of transaction types may have four different transaction types and may include search requests, order placement requests, and two other transactions types. The tested web server 133 will be allowed to quiesce. The use of the transaction queue, processing transactions within the second allowed group on the tested web server 133, and collecting data can be performed substantially similar to the procedure described for the first allowed group of transaction types.

After the transactions within the second allowed group of transaction types complete processing on the tested web server 133, the transaction throttle will be adjusted to remove the restriction to allow transactions, including transactions outside the second allowed group of transaction types, to be processed. The procedure is substantially similar to the procedure described for the catching up after processing transactions within the first allowed group.

The transaction throttle may be adjusted yet again to only allow transactions of a third allowed group of transaction types to pass. The third allowed group of transaction types may have only one transaction type, namely image requests. Because image requests may take a disproportionate amount of time to process compared to other transaction types, they are processed by themselves. The tested web server 133 will be allowed to quiesce. The use of the transaction queue, processing transactions within the third allowed group of transaction types on the tested web server 133, and collecting data can be performed substantially similar to the procedure described for the first allowed group of transaction types.

After the transactions within the third allowed group of transaction types complete processing on the tested web server 133, the transaction throttle will be adjusted to remove the restriction to allow transactions, including transactions outside the third allowed group of transaction types, to be processed. The procedure is substantially similar to the procedure described for the catching up after processing transactions within the first allowed group.

The method of quiescing, processing and collecting, and allowing the distributed computing environment 100 to catch up can be iterated for the rest of the groups of transaction types. The method can then be iterated for the rest of the web servers 133. In this example, information regarding each of the web servers 133 and their capacities used by each transaction type received by the web servers 133 has been determined. The appliance 150 can optimize the performance of the distributed computing environment 100 using the information collected. By using the example, the data regarding the web servers 133 and capacities can be analyzed and determined faster and more accurately compared to conventional methods.

Note that not all of the activities described above in the general description or the example are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all of the claims.

What is claimed is:

1. A method of determining usage of at least one component by at least one transaction type, wherein the method comprises:
processing one or more transactions using a distributed computing environment, wherein the one or more transactions includes a first transaction having a first transaction type;
collecting data from at least one instrument within the distributed computing environment during processing of the one or more transactions; and
determining which of the at least one component and its capacity is used by the first transaction type.

2. The method of claim 1, wherein the at least one component comprises more than one component, and determining is performed for more than one component.

3. The method of claim 1, further comprising allowing transactions of some, but not all, transaction types to pass, wherein processing is performed on the transactions allowed to pass.

4. The method of claim 3, further comprising:
processing a second transaction having a second transaction type different from the first transaction type, wherein the first and second transactions are processed simultaneously using the distributed computing environment during at least one point in time; and
determining which of the at least one component and its capacity is used by the second transaction type.

5. The method of claim 1, further comprising allowing transactions of only one transaction type to pass, wherein processing is performed on the transactions allowed to pass.

6. The method of claim 1, further comprising:
allowing the distributed computing environment to quiesce; and
processing is performed such that the first transaction is the only transaction being processed on the distributed computing environment.

7. The method of claim 1, further comprising conditioning the data before determining which of the at least one component and its capacity is used by the first transaction type.

8. The method of claim 1, wherein determining which of the at least one component is used by the first transaction type is performed using a deterministic technique.

9. The method of claim 1, wherein determining which of the at least one component is used by the first transaction type is performed using a statistical technique.

10. The method of claim 9, wherein the statistical technique is performed using regression.

11. The method of claim 1, wherein the one or more components correspond to one or more processors, and the capacity relates to processor cycles used by the first transaction type.

12. The method of claim 1, further comprising determining an accuracy based on the data used for determining which of the at least one component and its capacity is used by the first transaction type.

13. The method of claim 1, wherein the method is iterated for each component having a same component type.

14. The method of claim 1, wherein:
the method further comprises allowing a first set of transactions to pass, wherein each transaction within the first set of transactions has a transaction type within a first allowed group;
processing comprises processing the first set of transactions using the distributed computing environment;
collecting comprises collecting first data from at least some of the instruments within the distributed computing environment during processing the first set of transactions;
the method further comprises:
allowing a second set of transactions to pass to significantly reduce a queue of transactions, wherein:
at least one transaction within the second set of transactions has a second transaction type; and
the second transaction type is not within the first allowed group;
processing the second set of transactions using the distributed computing environment, wherein processing the second set of transactions is performed after processing the first set of transactions; and
allowing a third set of transactions to pass, wherein:
each transaction within the third set of transactions has a transaction type within a second allowed group; and
the first transaction type does not belong to the second allowed group;
processing the third set of transactions using the distributed computing environment, wherein processing the third set of transactions is performed after processing the second set of transactions;
collecting second data from at least some of the instruments within the distributed computing environment during processing of the third set of transactions; and
conditioning the first data and the second data; and
determining comprises determining which of the at least one component and its capacity is used by the first transaction type and which of the at least one component and its capacity is used by the third transaction type.

15. The method of claim 14, wherein the second transaction type and the third transaction type are a same transaction type.

16. An apparatus operable for carrying out the method of claim 1.

17. A data processing system readable medium having code for determining usage of at least one component in a distributed computing environment by at least one transaction type, wherein the code is embodied within the data processing system readable medium, the code comprising:
an instruction for processing one or more transactions using a distributed computing environment, wherein the one or more transactions includes a first transaction having a first transaction type;
an instruction for collecting data from at least one instrument within the distributed computing environment during processing of the one or more transactions; and
an instruction for determining which of the at least one component and its capacity is used by the first transaction type.

18. The data processing system readable medium of claim 17, wherein the at least one component comprises more than one component, and an instruction for determining is repeated for more than one component.

19. The data processing system readable medium of claim 17, wherein the code further comprises an instruction for allowing transactions of some, but not all, transaction types to pass, wherein the instruction for processing is performed on the transactions allowed to pass.

20. The data processing system readable medium of claim 3, wherein the code further comprises:
an instruction for processing a second transaction having a second transaction type different from the first transaction type, wherein the first and second transactions are processed simultaneously using the distributed computing environment during at least one point in time; and
an instruction for determining which of the at least one component and its capacity is used by the second transaction type.

21. The data processing system readable medium of claim 17, wherein the code further comprises an instruction for allowing transactions of only one transaction type to pass, wherein the instruction for processing is performed on the transactions allowed to pass.

22. The data processing system readable medium of claim 17, wherein the code further comprises:
an instruction for allowing the distributed computing environment to quiesce; and
an instruction for processing is executed such that only the first transaction is the only transaction being processed on the distributed computing environment.

23. The data processing system readable medium of claim 17, wherein the code further comprises an instruction for conditioning the data before determining which of the at least one component and its capacity is used by the first transaction type.

24. The data processing system readable medium of claim 17, wherein the instruction for determining which of the at least one component is used by the first transaction type is performed using a statistical technique.

25. The data processing system readable medium of claim 24, wherein the statistical technique is performed using regression.

26. The data processing system readable medium of claim 17, wherein the one or more components correspond to one or more processors, and the capacity relates to processor cycles used by the first transaction type.

27. The data processing system readable medium of claim 17, wherein the code further comprises an instruction for determining an accuracy based on the data used for determining which of the at least one component and its capacity is used by the first transaction type.

28. The data processing system readable medium of claim 17, wherein method is iterated for each component having a same component type.

29. The data processing system readable medium of claim 17, wherein:
the code further comprises an instruction for allowing a first set of transactions to pass, wherein each transaction within the first set of transactions has a transaction type within a first allowed group;
the instruction for processing comprises processing the first set of transactions using the distributed computing environment;
the instruction for collecting comprises collecting first data from at least some of the instruments within the distributed computing environment during processing the first set of transactions;
the code further comprises:
an instruction for allowing a second set of transactions to pass to significantly reduce a queue of transactions, wherein:
at least one transaction within the second set of transactions has a second transaction type; and
the second transaction type is not within the first allowed group;
an instruction for processing the second set of transactions using the distributed computing environment, wherein the instruction for processing the second set of transactions is executed after the instruction for processing the first set of transactions; and
an instruction for allowing a third set of transactions to pass, wherein:
each transaction within the third set of transactions has a transaction type within a second allowed group; and
the first transaction type does not belong to the second allowed group;
an instruction for processing the third set of transactions using the distributed computing environment, wherein the instruction for processing the third set of transactions is executed after the instruction for processing the second set of transactions; and
an instruction for collecting second data from at least some of the instruments within the distributed computing environment during processing of the third set of transactions; and
an instruction for conditioning the first data and the second data; and
the instruction for determining comprises an instruction for determining which of the at least one component and its capacity is used by the first transaction type and which of the at least one component and its capacity is used by the third transaction type.

30. The data processing system readable medium of claim 29, wherein the second transaction type and the third transaction type are a same-transaction type.
